(19) United States
(12) Patent Application Publication
(10) Pub. No.: US 2015/0110611 A1
(43) Pub. Date: Apr. 23, 2015

(54) AIRFOIL COOLING CIRCUIT AND CORRESPONDING AIRFOIL

(71) Applicant: GENERAL ELECTRIC COMPANY, Schenectady, NY (US)

(72) Inventor: Robert Frederick Bergholz, West Chester, OH (US)

(21) Appl. No.: 14/399,572

(22) PCT Filed: May 28, 2013
(86) PCT No.: PCT/US2013/042837

§ 371 Date: Nov. 7, 2014

Related U.S. Application Data
(60) Provisional application No. 61/653,681, filed on May 31, 2012.

(51) Int. Cl. F01D 5/14; F01D 25/12; F01D 5/18

(52) U.S. Cl. CPC F01D 5/147; F01D 5/18; F01D 25/12; F05D 2210/40; F05D 2260/221
USPC 415/178; 416/97 A

(57) ABSTRACT

An airfoil cooling circuit for a gas turbine engine having at least one internal cavity with a lobed cross-sectional shape.

### BACKGROUND OF THE INVENTION

The technology described herein relates generally to cooling circuits for airfoils, and more particularly to such cooling circuits for use in turbine airfoils for gas turbine engines.

Many gas turbine engine assemblies include cooling circuits in rotating airfoils, such as high pressure or low pressure turbine blades, and/or non-rotating stationary airfoils, such as high pressure or low pressure turbine nozzles.

During operation, comparatively cooler air is supplied to the airfoil in order to maintain the temperature of the material from which the airfoil is made below the melting or softening temperature. Typically airfoils are cooled either by an impingement circuit, where the post impingement air flows axially out of the airfoil, or a serpentine circuit where the flow direction is primarily radial and cools by means of forced convection.

Most production turbine airfoil cooling circuits have a “serpentine” design consisting of a series of single or multi-pass radial cooling channels. Such circuits often have weak control of “hot spots” caused by variation in external hot-gas temperature and heat transfer coefficients. Newer, near-wall cooling designs give somewhat better control, but significant thermal gradients and hot spots often still occur. Generally, cooling features such as turbulators, pins, or bumps have been employed in local areas to reduce peak temperatures, but success has been limited. Much smaller near-wall cavities, or micro-channels, could be used, but these present a considerable fabrication challenge for cores and castings.

There remains a need for improved cooling circuits which will provide cooling to an airfoil in a robust and economical fashion.

### BRIEF DESCRIPTION OF THE INVENTION

An airfoil cooling circuit for a gas turbine engine having at least one internal cavity with a lobed cross-sectional shape.

### BRIEF DESCRIPTION OF THE DRAWINGS

FIG. 1 is a cross-sectional illustration of an exemplary gas turbine engine assembly;

FIG. 2 is a cross-sectional illustration of an airfoil with a prior art cooling circuit;

FIG. 3 is a cross-sectional illustration of an airfoil with an exemplary cooling circuit;

FIG. 4 is a cross-sectional illustration similar to FIG. 3 but illustrating another exemplary cooling circuit; and

FIG. 5 is a series of enlarged cross-sectional illustrations depicting various exemplary embodiments of the pressure side region P shown in FIG. 3;

FIG. 6 is a series of enlarged cross-sectional illustrations depicting various exemplary embodiments of the suction side region S shown in FIG. 3; and

FIGS. 7 and 8 each contain a series of illustrations comparing a baseline cavity shape 81 with various degrees of contour in exemplary embodiments 82.

### DETAILED DESCRIPTION OF THE INVENTION

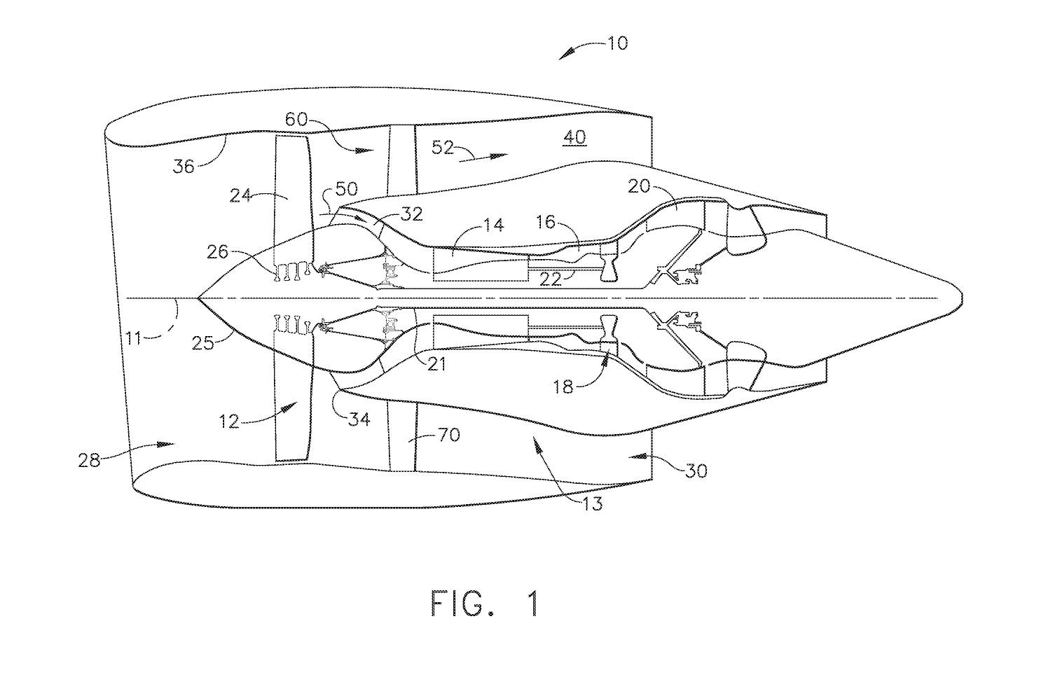

FIG. 1 is a cross-sectional schematic illustration of an exemplary gas turbine engine assembly 10 having a longitudinal axis 11. Gas turbine engine assembly 10 includes a fan assembly 12 and a core gas turbine engine 13. Core gas turbine engine 13 includes a high pressure compressor 14, a combustor 16, and a high pressure turbine 18. In the exemplary embodiment, gas turbine engine assembly 10 also includes a low pressure turbine 20, and a multi-stage booster compressor 32, and a splitter 34 that substantially circumscribes booster 32.

Fan assembly 12 includes an array of fan blades 24 extending radially outward from a rotor disk 26, the forward portion of which is enclosed by a streamlined spinner 25. Gas turbine engine assembly 10 has an intake side 28 and an exhaust side 30. Fan assembly 12, booster 22, and turbine 20 are coupled together by a first rotor shaft 21, and compressor 14 and turbine 18 are coupled together by a second rotor shaft 22.

In operation, air flows through fan assembly 12 and a first portion 50 of the airflow is channeled through booster 32. The compressed air that is discharged from booster 32 is channeled through compressor 14 wherein the airflow is further compressed and delivered to combustor 16. Hot products of combustion (not shown in FIG. 1) from combustor 16 are utilized to drive turbines 18 and 20, and turbine 20 is utilized to drive fan assembly 12 and booster 32 by way of shaft 21. Gas turbine engine assembly 10 is operable at a range of operating conditions between design operating conditions and off-design operating conditions.

A second portion 52 of the airflow discharged from fan assembly 12 is channeled through a bypass duct 40 to bypass a portion of the airflow from fan assembly 12 around core gas turbine engine 13. More specifically, bypass duct 40 extends between a fan casing or shroud 36 and splitter 34. Accordingly, a first portion 50 of the airflow from fan assembly 12 is channeled through booster 32 and then into compressor 14 as described above, and a second portion 52 of the airflow from fan assembly 12 is channeled through bypass duct 40 to provide thrust for an aircraft, for example. Splitter 34 divides the incoming airflow into first and second portions 50 and 52, respectively. Gas turbine engine assembly 10 also includes a fan frame assembly 60 to provide structural support for fan assembly 12 and is also utilized to couple fan assembly 12 to core gas turbine engine 13.

Fan frame assembly 60 includes a plurality of outlet guide vanes 70 that extend substantially radially between a radially outer mounting flange and a radially inner mounting flange and are circumferentially-spaced within bypass duct 40. Fan frame assembly 60 may also include a plurality of struts that are coupled between a radially outer mounting flange and a radially inner mounting flange. In one embodiment, fan frame assembly 60 is fabricated in arcuate segments in which flanges are coupled to outlet guide vanes 70 and struts. In one embodiment, outlet guide vanes and struts are coupled coaxially within bypass duct 40. Optionally, outlet guide vanes 70 may be coupled downstream from struts within bypass duct 40.

Fan frame assembly 60 is one of various frame and support assemblies of gas turbine engine assembly 10 that are used to facilitate maintaining an orientation of various components within gas turbine engine assembly 10. More specifically, such frame and support assemblies interconnect stationary components and provide rotor bearing supports. Fan frame assembly 60 is coupled downstream from fan assembly 12 within bypass duct 40 such that outlet guide vanes 70 and struts are circumferentially-spaced around the outlet of fan assembly 12 and extend across the airflow path discharged from fan assembly 12.

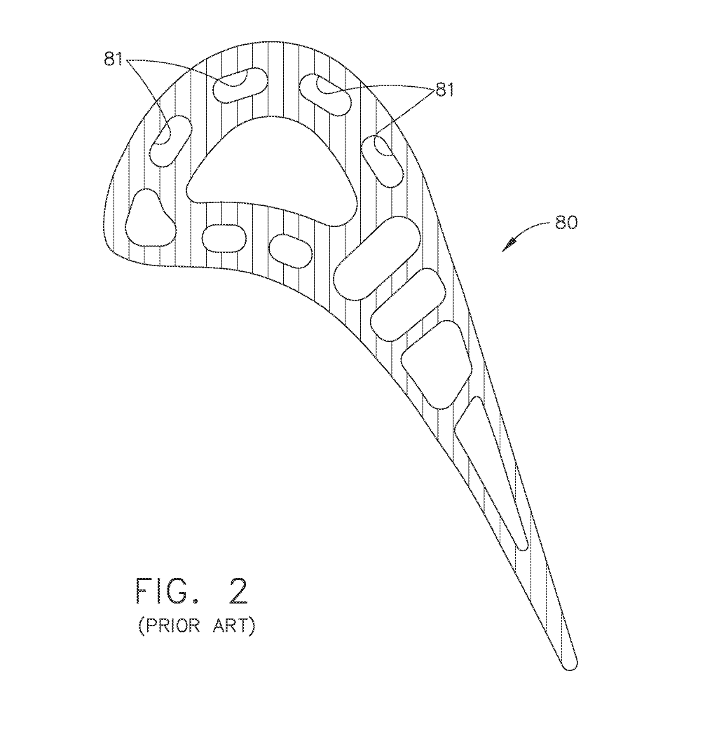

As shown in FIGS. 2-4, the airfoil 80 is provided with a serpentine cooling circuit which supplies cooling air to the interior of the airfoil and through cooling holes in the exterior surfaces of the airfoil. FIG. 2 illustrates a prior art conventional cooling circuit design, wherein a plurality of internal cavities 81 are positioned adjacent to the pressure and/or suction side of the airfoil. As shown in FIG. 2, each of these cavities 81 has a cross-sectional shape taken in a chordwise direction such that the perimeter of the cavity has a conventional “racetrack” configuration with two opposed parallel sides and two semicircular opposed ends.

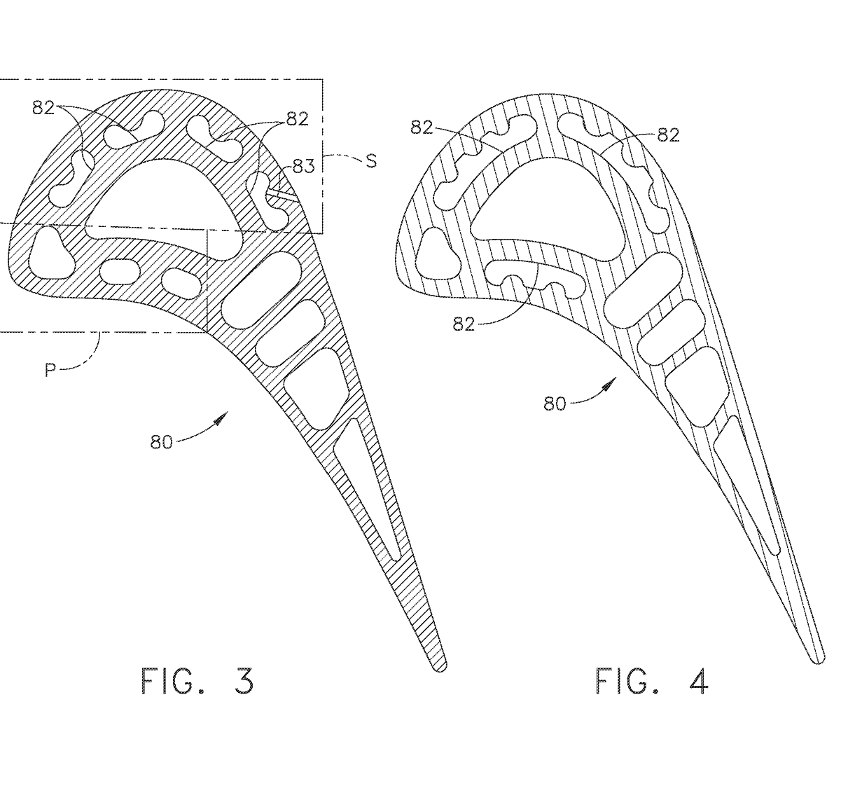

FIG. 3 illustrates an exemplary cooling circuit design as described herein. The airfoil 80 in FIG. 3 is discussed in the context of a pressure side region P and a suction side region S, and is provided with a plurality of internal cavities 82. At least some cavities 82 may include integral film cooling holes 83 to discharge cooling air onto the surface of the airfoil 80. In contrast to the “racetrack” configuration of the cavities 81 of FIG. 2, the cavities 82 of FIG. 3 depict a “lobed” cross-sectional shape taken in a chordwise direction. Such a configuration provides enhanced cooling to the surface of the airfoil which is exposed to heat transfer from flow over the airfoil during operation of the gas turbine engine, while managing the consumption of cooling air. The flow area for each “lobed” shaped cavity 82 is equal to that of the baseline “racetrack” shaped cavity 81 it replaces.

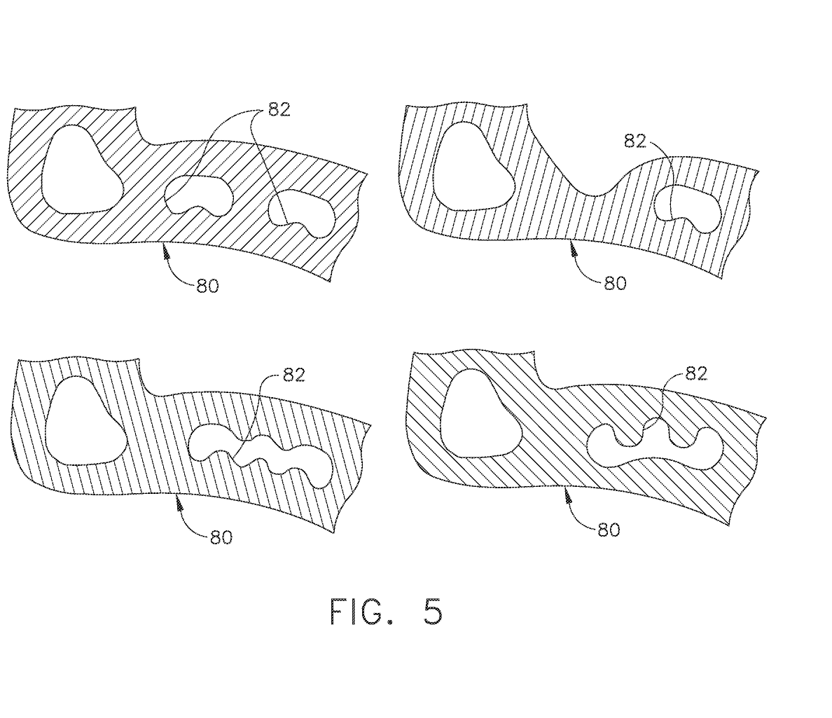

FIG. 4 depicts an alternate configuration of an airfoil 80 wherein the cavities 82 have a multiple lobed shape, i.e., with more than the two lobes depicted in FIG. 3.

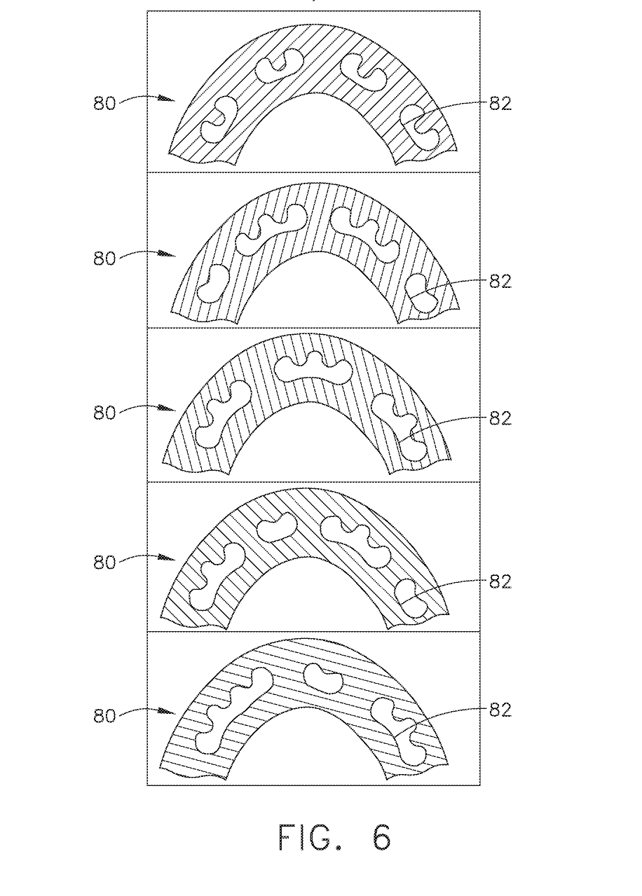

FIG. 5 depicts four potential embodiments of the pressure side region P identified in FIG. 3, each of which illustrates variations in the number, orientation, and shape of the cooling cavities 82 in the pressure side region P including variations in the number of lobes.

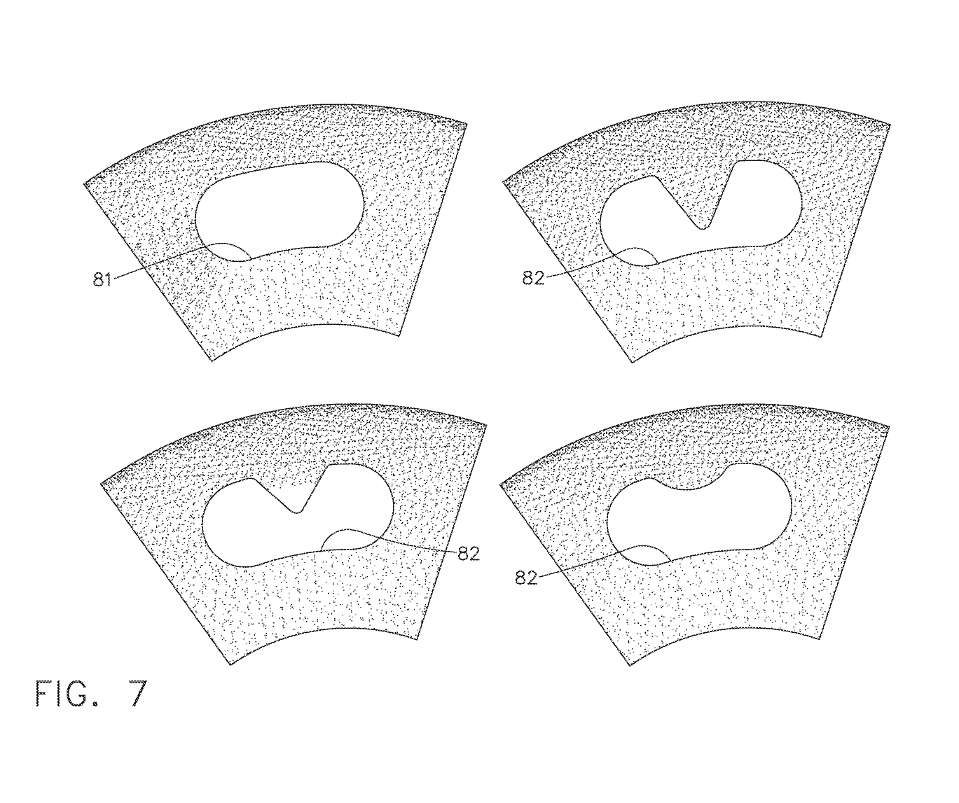

FIG. 6 depicts five potential embodiments of the suction side region S identified in FIG. 3, each of which illustrates variations in the number, orientation, and shape of the cooling cavities 82 in the suction side region S including variations in the number of lobes.

A possible commercial advantage of cooling circuits described herein would be lower airfoil cooling flow which would improve engine specific fuel consumption. A technical advantage of this design would be the decreased temperature gradient across the airfoil which would yield lower engine operating airfoil stress and improve part life and durability.

Next-generation turbine blades often utilize near-wall cooling cavities. The near-wall cooling cavities are designed with lobed shapes as shown in FIGS. 3 and 4 to control the cooling channel flow area and internal heat transfer coefficient variations along the radial span of the airfoil, and also provide internal heat transfer enhancement by increased cavity perimeter and high near-wall fin effectiveness from the lobe or similar geometric feature on the hot wall. The lobes can have varying width and penetration depths into the cavities to smooth out wall temperature gradients in response to the external airfoil gas temperature and heat transfer coefficient distributions. A unique way to produce lobes or other near-wall cavity shapes is by using the so-called “generalized super-shape equation”. One form of this equation, in polar coordinate form, is:

$$\frac{1}{r} = \sqrt[{n}_{1}]{{\vert \frac{1}{a} cos ( \frac{m}{4} φ ) \vert}^{{n}_{2}} + {\vert \frac{1}{b} sin ( \frac{m}{4} φ ) \vert}^{{n}_{3}}}$$

The super-shape equation has found applications in a number of engineering fields. This equation, and functional modification thereto for specific geometrics, was used for the first time in the turbine cooling field to produce many cavity unique, customized cavity shapes in the course of parametric design studies on shaped near-wall cooling cavities, and it is a novel and very useful feature of this design approach. The shaped cavities can provide greater coverage over the hot wall, as well as enhanced internal heat transfer, versus a simple, conventional racetrack shape such as shown in FIG. 2. The lobed shapes can be design to accept film holes (such as element 83 in FIG. 3) that would increase heat transfer by bore cooling and allow better local wall thickness for manufacturing. Certain shapes will induce vortical flow in the cavity, which also improves the internal heat transfer coefficient, and parametric CFD modeling with the super-shape equation can be used to create highly customized designs. The shaped cavities also improve the core stiffness of the long radial cavities by way of an “I-beam” effect. The single-lobe cavity was demonstrated in core fabrication trials using the DCD process. A number of ANSYS thermal design studies were performed for turbine airfoil near-wall cavities of various shapes. The results show significant reductions peak wall temperatures of 40 degrees F. or greater, which correlates to approximately a 3×improvement in part life.

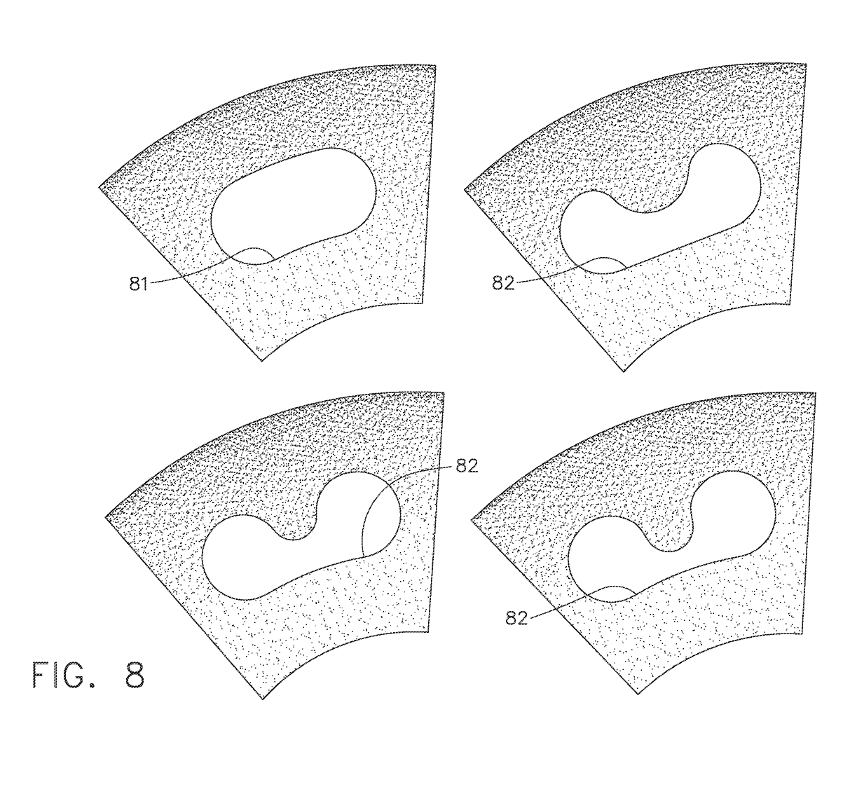

FIGS. 7 and 8, respectively, each contain a series of illustrations comparing a baseline cavity shape 81 with various degrees of contour in exemplary embodiments 82 generated utilizing a super-shape equation as described herein.

One approach to designing and implementing shaped cooling cavities is as follows: 1. A castable, shaped near-wall cavity, possibly with radial area variation, is constructed having a single or multi-lobe shape of a form design to minimize peak temperatures and thermal gradients in the turbine airfoil wall. These lobe shapes are arbitrary in width and penetration into the cavity, and may have any producible form. A highly useful method of producing such shapes in the “super-shape” equation. 2. The lobe geometry controls the radial flow and internal heat transfer coefficient variation along the cavity. 3. The penetrating lobes also act as high-efficiency fins, and with customized shape geometries, enable an axial and radial smoothing of the airfoil wall temperature variation and a reduction in wall peak temperatures. 4. The shapes cavities can also produce favorable vortex flows in the plane of the cavity, thereby creating more desirable heat transfer coefficient distributions around the cavity perimeter.

Shaped cavities described here allow significant improvements in the ability to customize turbine wall heat transfer to minimize the effects of hot spots and thermal gradients. Shaped cavities can be cast, and cores produced, by disposable core die (DCD) methods and apparatus such as those known in the art. Lobed shapes also provide added stiffness to cavity cores. Reductions exceeding 40 degrees F. have been calculated for typical designs.

The technical advantages are: (1) potentially reduced turbine cooling flow, which produces better engine performance and lower SCF, (2) lower peak airfoil wall metal temperatures and wall thermal gradients, (3) reduced wall thermal stress, and (4) the designs can be made castable by either conventional or the newer DCD core fabrication processes.

While the invention has been described in terms of various specific embodiments, those skilled in the art will recognize that the invention can be practiced with modification within the spirit and scope of the claims.

What is claimed is:

1. An airfoil cooling circuit for a gas turbine engine comprising:
at least one internal cavity;
wherein said cavity has a lobed cross-sectional shape.

2. An airfoil cooling circuit according to claim 1, wherein said cavity has a cross-sectional shape characterized by a generalized super-shape equation.

3. An airfoil cooling circuit according to claim 2, wherein said generalized super-shape equation in polar coordinate form is:
$$\frac{1}{r} = \sqrt[{n}_{1}]{{\vert \frac{1}{a} cos ( \frac{m}{4} φ ) \vert}^{{n}_{2}} + {\vert \frac{1}{b} sin ( \frac{m}{4} φ ) \vert}^{{n}_{3}}} .$$

4. An airfoil cooling circuit according to claim 1, wherein said cooling circuit has a plurality of internal cavities each having a cross-sectional shape characterized by a generalized super-shape equation.

5. An airfoil cooling circuit according to claim 1, wherein said cross-sectional shape is defined in a chordwise direction.

6. An airfoil cooling circuit according to claim 1, wherein said cooling circuit is a serpentine cooling circuit.

7. An airfoil cooling circuit according to claim 1, wherein said cross-sectional shape has a plurality of lobes.

8. An airfoil cooling circuit according to claim 1, wherein said cross-sectional shape has more than two lobes.

9. An airfoil cooling circuit according to claim 1, wherein said cooling circuit has a plurality of internal cavities each having a cross-sectional shape with a different number of lobes.

10. An airfoil cooling circuit according to claim 1, wherein said at least one cavity includes at least one integral film cooling hole to discharge cooling air onto the surface of an airfoil.

11. An airfoil for a gas turbine engine, said airfoil comprising:
an airfoil surface defining an exterior surface of said airfoil and an interior of said airfoil inwardly of said exterior surface;
a cooling circuit which supplies cooling air to said interior of said airfoil and through cooling holes in said exterior surfaces of said airfoil;
wherein said cooling circuit has at least one internal cavity having a lobed cross-sectional shape

12. An airfoil according to claim 11, wherein said cavity has a cross-sectional shape characterized by a generalized super-shape equation.

13. An airfoil according to claim 12, wherein said generalized super-shape equation in polar coordinate form is:
$$\frac{1}{r} = \sqrt[{n}_{1}]{{\vert \frac{1}{a} cos ( \frac{m}{4} φ ) \vert}^{{n}_{2}} + {\vert \frac{1}{b} sin ( \frac{m}{4} φ ) \vert}^{{n}_{3}}} .$$

14. An airfoil according to claim 11, wherein said cooling circuit has a plurality of internal cavities having a cross-sectional shape characterized by a generalized super-shape equation.

15. An airfoil according to claim 11, wherein said cross-sectional shape is defined in a chordwise direction.

16. An airfoil according to claim 11, wherein cooling circuit is a serpentine cooling circuit.

17. An airfoil according to claim 11, wherein said cross-sectional shape has a plurality of lobes.

18. An airfoil according to claim 11, wherein said cross-sectional shape has more than two lobes.

19. An airfoil according to claim 11, wherein said cooling circuit has a plurality of internal cavities each having a cross-sectional shape with a different number of lobes.

20. An airfoil according to claim 11, wherein said at least one cavity includes at least one integral film cooling hole to discharge cooling air onto said airfoil surface.
